(19) United States
(12) Patent Application Publication
(10) Pub. No.: US 2026/0352555 A1
(43) Pub. Date: Nov. 5, 2026

(54) METHOD AND APPARATUS FOR PREDICTING TRAFFIC IN CELLS OF A WIRELESS COMMUNICATION NETWORK

(71) Applicant: Telefonaktiebolaget LM Ericsson (publ), Stockholm (SE)

(72) Inventors: Mohammad Reza GHOLAMI, Stockholm (SE); Rerngvit YANGGRATOKE, JÄRFÄLLA (SE); Ebby GEORGE, SOLNA (SE); Göran ERIKSSON, NORRTÄLJE (SE)

(73) Assignee: Telefonaktiebolaget LM Ericsson (publ), Stockholm (SE)

(21) Appl. No.: 19/478,533

(22) PCT Filed: Apr. 25, 2023
(86) PCT No.: PCT/SE2023/050377

§ 371 Date: Oct. 24, 2025

(51) Int. Cl. H04L 41/147

(52) U.S. Cl. CPC H04L 41/147

(57) ABSTRACT

Prediction of traffic load for each cell in a population of cells of a Radio Access Network (RAN) involves an advantageous approach in which historical data regarding traffic loads for all cells in the population provides a basis for identifying traffic behavior groups within the population, determining traffic load relationships between a representative cell in each group and remaining cells in the group, and training traffic prediction models on a group basis. In turn, that arrangement allows, as one of several advantages, accurate predictions of traffic loads for the population of cells, based on collecting traffic load data only for the representative cells, thus dramatically reducing the frequency at which traffic load data for the whole population must be collected.

### TECHNICAL FIELD

The present invention relates to wireless communication networks, and particularly relates to predicting traffic load in cells of a Radio Access Network (RAN).

### BACKGROUND

“Traffic” in the context of communications networks refers to the data carried by those networks, with the data going between respective endpoints. “Traffic load” refers to the volume or rate of traffic and it may be assessed with respect to one or more defined intervals, such as minutes, hours, days, weeks, etc. While one may refer to the traffic load of the overall communications network, assessment of traffic load at a more granular level is more meaningful because it reveals how much traffic is carried by different parts of the network.

Per-cell data on traffic loads represents a particularly useful level of granularity in the context of Radio Access Networks (RANs) because it provides for evaluation of relative traffic loading between or among the cells. In turn, such evaluations inform any number of critical operations, such as network control operations, network planning operations, or resource optimization operations.

However, a wireless communications network may include more than one RAN, and each RAN may include hundreds or even thousands of cells. In this context, a “cellular network” refers to the use of cells to divide a large geographic area into smaller, more manageable areas that can be served by a network of radio access nodes. The divisions enable efficient use of radio spectrum and allow for the reuse of communication resources across the cells, according to a defined reuse pattern that minimizes inter-cell interference. Of course, two different cells may involve the same geographic area, such as where two radio access nodes provide network coverage over the same area using different carrier frequencies. Further, cells may be dynamic, such as in the context of beamforming and beam steering.

Further, the data reflecting the “traffic load” of a cell may include multiple items, such as the number of active User Equipments (UEs), the number of Radio Resource Configurations (RRC), information detailing utilization of Physical Resource Blocks (PRBs), etc. Such data may be collected over specific time durations, such as per minute, per quarter hour, per hour, per day, per week, etc. Consequently, transferring traffic load data from all cells in a large RAN represents a significant burden in terms of the potentially large geographic separation between respective RAN nodes and the collection point, the aggregate amount of data to be transferred, and the repeating nature of the transfers.

### SUMMARY

Prediction of traffic load for each cell in a population of cells of a Radio Access Network (RAN) involves an advantageous approach in which historical data regarding traffic loads for all cells in the population provides a basis for identifying traffic behavior groups within the population, determining traffic load relationships between a representative cell in each group and remaining cells in the group, and training traffic prediction models on a group basis. In turn, that arrangement allows, as one of several advantages, accurate predictions of traffic loads for the population of cells, based on collecting traffic load data only for the representative cells, thus dramatically reducing the frequency at which traffic load data for the whole population must be collected.

One embodiment comprises a method of operation by a node in a wireless communication network that includes a cellular Radio Access Network (RAN). The method includes collecting historic traffic data for all cells in a population of geographically distributed cells provided by the RAN, and using the historic traffic data to: (a) identify traffic behavior groups among the population of cells, based on this historic traffic data, each traffic behavior group being a disjoint subset of two or more cells from the population of cells and containing a representative cell and one or more remaining cells; (b) determine a corresponding mapping function for each remaining cell in each traffic behavior group, the corresponding mapping function relating traffic loading in the representative cell to the remaining cell; and (c) train a corresponding traffic prediction model for each traffic behavior group. The method further includes collecting new traffic data only for the representative cells, and using the new traffic data to: (d) predict a traffic load for each representative cell by inputting the new traffic data for the representative cell into the corresponding traffic prediction model; (e) predict a traffic load for each remaining cell by inputting the predicted traffic load of the corresponding representative cell into the corresponding mapping function; and (f) output the predicted traffic loads for all cells in the population, for one or more of network control operations, network planning operations, or resource optimization operations.

A related embodiment comprises a node that is configured for operation in a wireless communication network that includes a cellular (RAN). The node includes communication circuitry and processing circuitry, where the processing circuitry is configured to collect, via the communication circuitry, historic traffic data for all cells in a population of geographically distributed cells provided by the RAN and use the historic traffic data to: (a) identify traffic behavior groups among the population of cells, based on this historic traffic data, each traffic behavior group being a disjoint subset of two or more cells from the population of cells and containing a representative cell and one or more remaining cells; (b) determine a corresponding mapping function for each remaining cell in each traffic behavior group, the corresponding mapping function relating traffic loading in the representative cell to the remaining cell; and (c) train a corresponding traffic prediction model for each traffic behavior group. Further, the processing circuitry is configured to collect new traffic data only for the representative cells and use the new traffic data to: (d) predict a traffic load for each representative cell by inputting the new traffic data for the representative cell into the corresponding traffic prediction model; (e) predict a traffic load for each remaining cell by inputting the predicted traffic load of the corresponding representative cell into the corresponding mapping function; and (f) output the predicted traffic loads for all cells in the population, for one or more of network control operations, network planning operations, or resource optimization operations.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communications network, according to one embodiment.

FIG. 2 is a block diagram of a Radio Access Network (RAN) within a communications network, according to one embodiment.

FIG. 3 is a block diagram of an example population of cells provided by a RAN.

FIG. 4 is a block diagram of example traffic behavior groups formed from a population of cells of a RAN.

FIG. 5 is a block diagram of example predictions of traffic load performed via trained traffic prediction models corresponding to traffic behavior groups.

FIG. 6 is a block diagram of determining traffic behavior groups and performing per group training of traffic prediction models.

FIG. 7 is a block diagram of a network node for predicting traffic data based on prediction models trained on per traffic behavior group basis, according to one embodiment.

FIGS. 8 and 9 are logic flow diagrams depicting a method operation in one embodiment, wherein a network node performs training of traffic prediction models corresponding to identified traffic behavior groups and performs traffic load predictions based on the training.

FIGS. 10A and 10B are block diagrams of example training-phase and predicting phase operations, for traffic load prediction.

FIG. 11 is a block diagram of example details for the use of mapping functions to relate traffic loading in one cell to another cell.

FIG. 12 is a block diagram of an implementation of traffic prediction using virtualized servers, according to one embodiment.

### DETAILED DESCRIPTION

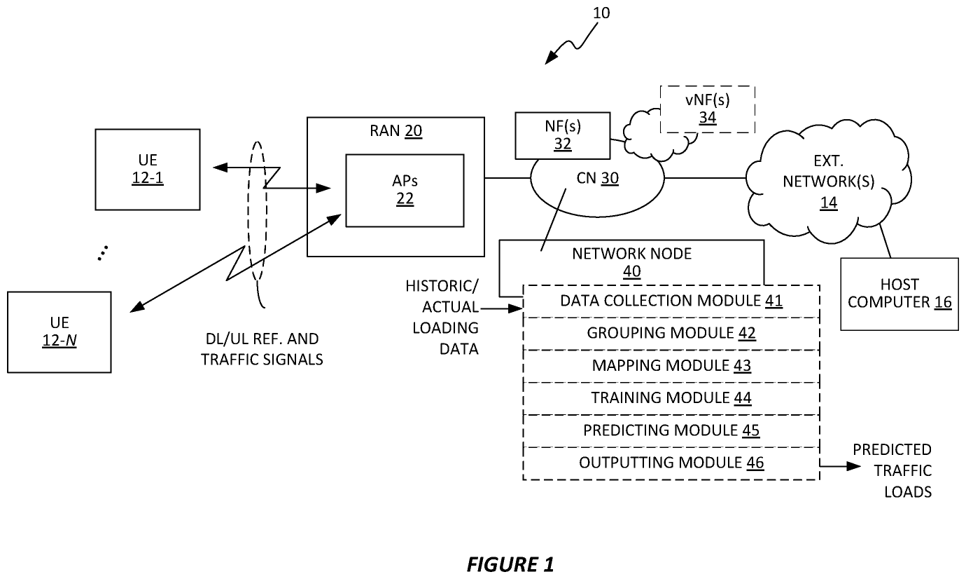

FIG. 1 illustrates a communications network 10 (“network 10”) according to one embodiment, wherein the network 10 provides one or more types of communication services to user equipments (UEs) 12. There may be many UEs 12 active at any given time and the diagram illustrates an indeterminate number of UEs 12-1 through 12-N, with the understanding that the reference number “12” without suffixing refers to any given UE or group of UEs, with suffixing used only where distinguishing between particular UEs aids clarity.

Communication services include, for example, mobile broadband services of other data connectivity services, such as where the network 10 provides UEs 12 with access to one or more external networks 14, such as the Internet. A particular example involves the network 10 providing UEs 12 with access to various Internet-based services, such as by connecting given UEs to one or more host computers 16 for exchanging data of one or more types.

In one or more embodiments, the network 10 is a wireless communications network. In at least one embodiment, the network 10 is a cellular communications network configured according to Third Generation Partnership Project (3GPP) specifications.

A Radio Access Network (RAN) 20 of the network 10 includes one or more access points (APs) 22 that provide one or more types of air interfaces for wirelessly coupling UEs 12 to the RAN 20. Each AP 22 provides wireless network coverage over one or more geographic regions and transmits downlink (DL) signals for UEs 12 within its coverage area(s) and receives uplink (UL) signals from such UEs 12.

A Core Network (CN) 30 of the network 10 includes a number of network functions (NFs) 32 that provide authentication and access control for UEs 12 and manage mobility of individual UEs 12 as they move within and across the respective coverage areas provided by the APs 22. The NFs 32 further provide connectivity and routing functions with respect to user traffic exchanged between respective ones of the UEs 12 and external devices or systems accessible via the external network(s) 14. See 3GPP Technical Specification (TS) 38.300 V17.4.0 for example details of the network 10 in embodiments where the network 10 is based on 3GPP specifications for Fifth Generation (5G) networks.

One or more of the NFs 32 may be implemented as virtualized NFs (VNFs) 34 implemented via corresponding processing and storage circuitry in a cloud data center. Indeed, although not explicitly shown in FIG. 1, various portions of the RAN 20 may be implemented in the cloud. In one such example, the APs 22 are split into respective remote radio units (RRUs) and digital units (DUs), with some or all of the DU functionality implemented in a cloud RAN environment.

A point of particular interest is the network node 40 depicted in FIG. 1, which is configured for an advantageous technique for prediction of traffic loads in the network 10.

Prediction of traffic loads serves any one or more operational and planning functions, such as performing live management of network resources or performing various network planning functions. Among its numerous advantages, the prediction technique in any one or more embodiments (1) significantly reduces the amount of data transfer within the network 10, while enabling traffic prediction for all RAN cells, (2) obviates the need for tedious and laborious manual configuration, and (3) adaptively adjusts the amount of data to be transferred between high and low time frames to further minimize required data transfer within the network 10. Among the mechanisms used to achieve these advantages are behavioral clustering, which includes identifying traffic behavior groups among a population of cells, determining mapping functions that interrelate traffic loading within each traffic behavior group, and training traffic prediction models corresponding to the respective traffic behavior groups.

The network node 40, which may be a computer server, which may be implemented in a virtualized computing environment in a cloud computing center, includes a number of processing units or modules that cooperate for implementation of the advantageous prediction technique. Here, a processing unit or module is a logic function implemented via underlying processing circuitry, and an example set of such modules includes: (1) a data collection module 41 configured to collect historic traffic data for all cells in a population of cells provided by the RAN 20, (2) a grouping module 42 configured to use the historic traffic data to identify traffic behavior groups among the population of cells, (3) a mapping module 43 configured to identify mapping functions that relate the traffic behavior of remaining cells in each traffic behavior group to a reference cell in the group, (4) a training module 44 configured to train a traffic prediction model for each traffic behavior group, (5) a predicting module 45 configured to use new traffic data collected only for the reference cells to predict traffic loads for all cells, and (6) an outputting module 46 to output predicted traffic loads.

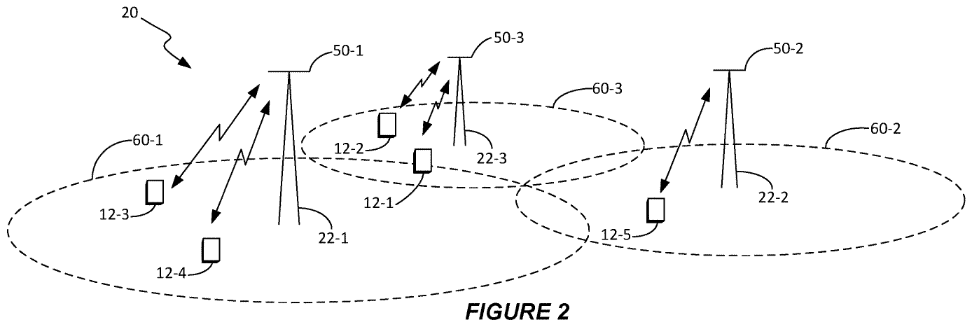

FIG. 2 illustrates additional example details helpful for framing a more detailed discussion of the advantageous prediction technique, where each AP 22 includes or is associated with a transmit/receive (TX/RX) antenna system 50, e.g., an AP 22-1 is associated with a TX/RX antenna system 50-1, an AP 22-2 is associated with a TX/RX antenna system 50-2, and so on. Each antenna system 50 allows the associated AP 22 to provide network coverage over a corresponding geographic area referred to as a cell 60. Each cell 60, e.g., cells 60-1, 60-2, and so on, can be understood as a service region or subregion defined by particular communication resources provided by a particular AP 22. Of course, not all cells 60 need be of the same shape or size. For example, there may be a mix of large cells and small cells, and cells may partially or even fully overlap. An example of full overlap involves two cells having the same geographic footprint but distinguished in terms of carrier frequencies used for the DL/UL signals. Further, one or more cells may be dynamic, such as where one or more of the APs 22 use TX or RX beamforming.

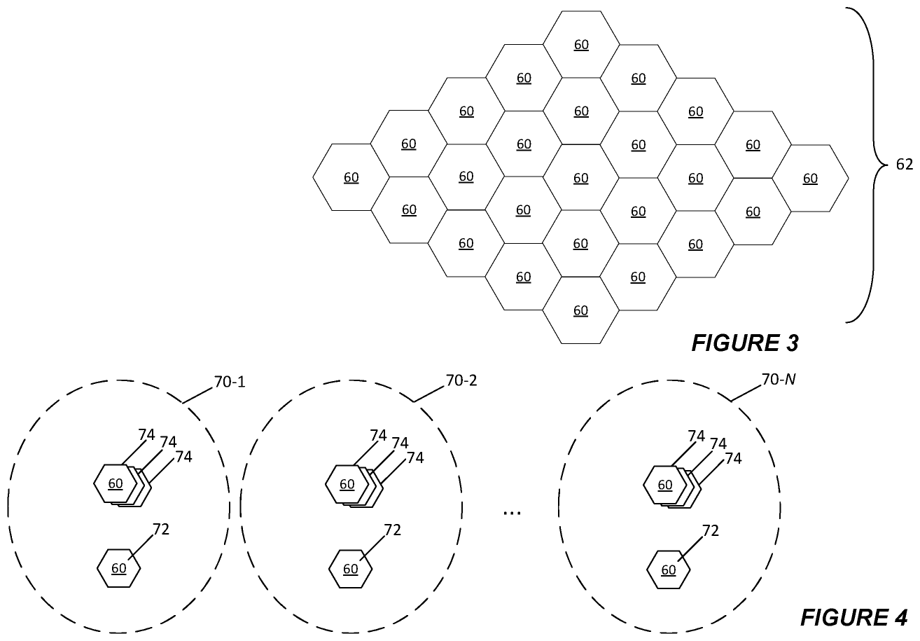

FIG. 3 illustrates a population 62 of geographically distributed cells 60 provided by the RAN 20 of the network 10, where the depicted arrangement of cells 60 is merely an example. FIG. 4 adds further details by depicting example traffic behavior groups 70, with groups 70-1 through 70-N shown merely as an example. Each traffic behavior group 70 includes a cell 60 designated as the representative cell 72, with the remaining cells 60 in the group 70 referred to as remaining cells 74.

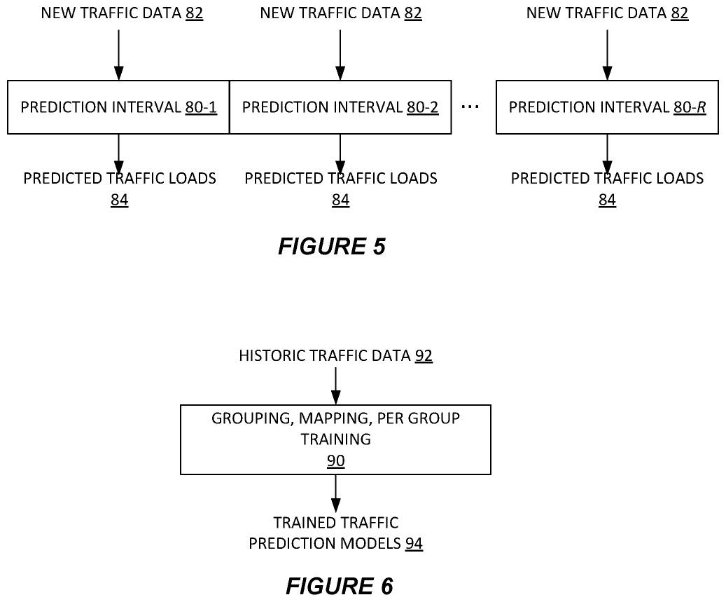

FIG. 5 illustrates advantageous traffic prediction for all cells 60 in a population 62, with predictions performed on a recurring basis in defined traffic prediction intervals 80, depicted as intervals 80-1 through 80-R. Prediction in each traffic prediction interval 80 relies on new traffic data 82 only for the representative cells 72 in each traffic behavior group 70, and with each prediction interval 80 resulting in the output of predicted traffic loads 84 for all cells 60 in the population 62. In other words, rather than transferring new traffic data 82 for all cells 60 in the population 62, performing a new prediction of traffic loads for all cells 60 in the population 62 only requires transferring new traffic data 82 for the representative cells 72.

Here, “new traffic data” refers to data that is current for a given prediction-interval basis. For example, to predict traffic loads for all cells 60 with respect to a next upcoming interval, the new traffic data 82 comprises the traffic loads experienced by the representative cells 72 during the immediately preceding interval, or for the most recent interval for which such data is available. These intervals may be minutes, quarter-hours, half-hours, hours, days, weeks, etc.

Further, the advantageous prediction may be performed with respect to each one of two or more defined intervals, such as with respect to hourly intervals and daily intervals. Again, with respect to any given defined interval, the advantageous prediction technique involves collecting new traffic data 82 only for the representative cells 72, rather than for all cells 60 in the population 62.

FIG. 6 illustrates the grouping, mapping, and training operations 90 that provide the basis for performing the per-interval predictions shown in FIG. 5. On a different timescale, generally one much slower than the prediction-interval timescale, the network node 40 collects historic traffic data 92 for all cells 60 in the population 62, with the grouping, mapping, and training operations 90 operating on the historic traffic data 92, to obtain the trained traffic prediction models 94 that are used with the new traffic data 82 in each prediction interval 80, for generating the predicted traffic loads 84 for all cells 60 in the population 62. The historic traffic data 92 may comprise explicit traffic load information, such as UE counts, number of calls/connections per unit of time, data throughputs, etc., or it may comprise information from which loading data may be derived.

For example, with respect to predicting traffic loads on an hourly basis, the RAN 20 may store per-minute traffic load data for each cell 60 in the population 62, and it may do so over a defined historical recording period that spans multiple hours, e.g., a day, two days, etc. Such operations allow the RAN 20 to build up historic traffic data 92 that reflects hourly traffic loading of all cells 60 in the population 62. The historic traffic data 92 may be transferred batchwise to the network node 40 at the conclusion of each historical recording period, or it may be incrementally transferred at lower bandwidths during each historical recording period. Of course, the RAN 20 may collect historic traffic data 92 for any one or more defined intervals, such as for per-minute traffic loading, per-hour traffic loading, etc.

In any case, the network node 40 collects the historic traffic data 92 from the RAN 20 or from one or more intermediate nodes having communicative access to the involved RAN nodes, and it uses the historic traffic data 92 to: (1) identify the traffic behavior groups 70, (2) determine mapping functions that relate traffic loading in the representative cell 72 in each traffic behavior group 70 to the traffic loading in the remaining cells 74 in the traffic behavior group 70, and (3) train per-group traffic prediction models. Having per-group traffic prediction models allows the involved machine-learning to learn traffic loading characteristics that are unique to cells 60 included in each traffic behavior group 70. For example, the traffic behavior groups 70 are based on geographic relationships, meaning that the traffic prediction models embody differences in loading behavior seen across clusters of cells 60 corresponding to different regions within the overall geographic area spanned by the RAN 20. Of course, the traffic behavior groups 70 may be formed by jointly considering multiple relationships, such that the traffic prediction models capture multiple, potentially nuanced differences in traffic loading among the cell groupings.

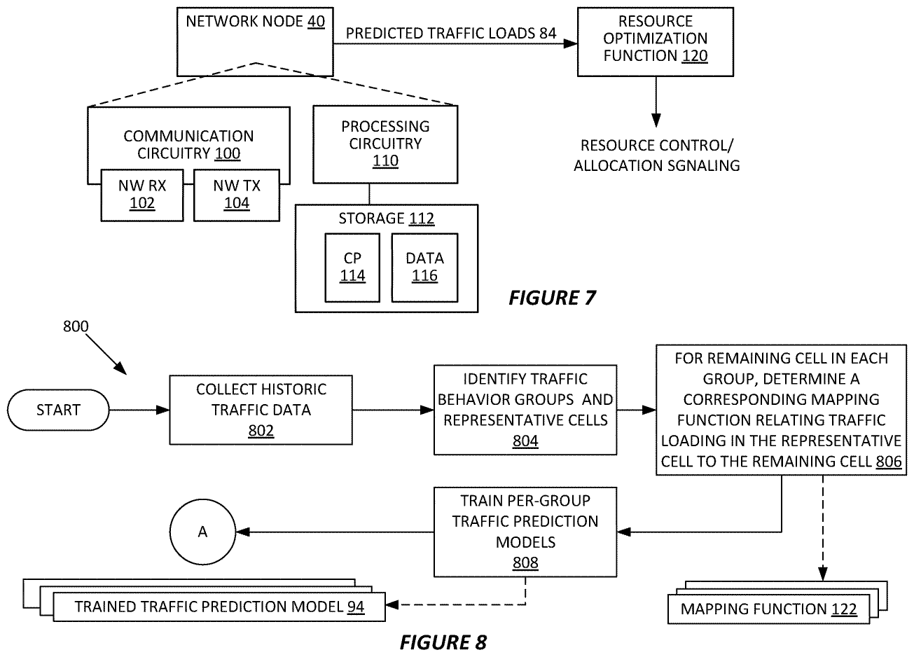

FIG. 7 illustrates a network node 40 configured to perform the advantageous prediction technique disclosed herein, with the understanding that the depicted arrangement corresponds to a non-limiting example embodiment. The network node 40 is configured for operation in a wireless communication network 10 that includes a cellular RAN 20 with the network node 40 comprising communication circuitry 100 that includes RX circuitry 102 and TX circuitry 104 that are configured to communicatively couple the network node 40 to one or more other nodes in the network 10, e.g., to other nodes for receiving historic or live traffic data indicating cell loading. In an example embodiment, the communication circuitry 100 comprises an Ethernet or other computer network interface.

The network node 40 further comprises processing circuitry 110, which comprises fixed circuitry or programmatically configured circuitry or a mix of both. In at least one embodiment, the network node 40 includes storage 112 comprising one or more types of computer readable media for storing one or more computer programs 114 and data 116. In at least one such embodiment, the processing circuitry 110 comprises one or more microprocessors that, based on executing computer program instructions stored in the storage 112, are specially adapted to carry out the advantageous traffic prediction technique described herein. The data 116 comprises, for example, dynamically updated data defining the traffic behavior groups 70, the representative cells 72, the remaining cells 74, and the trained prediction models used to predict traffic loading on per-group basis. Examples of the storage 112 include volatile memory, such as DRAM, for program execution and scratch data, and non-volatile memory, such as FLASH or Solid State Disk (SSD), for longer-term storage of program instructions, configuration data, etc.

However implemented, the processing circuitry 110 in an example embodiment is configured to: (a) collect historic traffic data 92 for all cells 60 in a population 62 of geographically distributed cells 60 provided by the RAN 20, where the historic traffic data 92 is received via the communication circuitry 100; and (b) use the historic traffic data 92 to (i) identify traffic behavior groups 70 among the population 62 of cells 60, each traffic behavior group 70 being a disjoint subset of two or more cells 60 from the population 62 of cells 60 and containing a representative cell 72 and one or more remaining cells 74, (ii) determine a corresponding mapping function for each remaining cell 74 in each traffic behavior group 70, the corresponding mapping function relating traffic loading in the representative cell 72 to the remaining cell 74, and (iii) train a corresponding traffic prediction model for each traffic behavior group 70.

The above operations may be referred to as training-phase operations and they may be performed repeatedly on a desired training interval, such as daily, weekly, or monthly, and the historic traffic data 92 may include load data for more than one defined load monitoring interval, such as per-minute loading history, per-hour loading history, etc. While the groupings may be the same across multiple training intervals, it will also be appreciated that the traffic behavior groupings 70 may change between intervals, or over a long stretch of time, in view of changing usage patterns, changes to the number or arrangement of cells 60, etc.

The processing circuitry 110 is further configured to (c) collect new traffic data 82 only for the representative cells 72, where the new traffic data 82 is collected via the communication circuitry 100, and (d) use the new traffic data 82 to (i) predict a traffic load for each representative cell 72 by inputting the new traffic data 82 for the representative cell 72 into the corresponding traffic prediction model, (ii) predict a traffic load for each remaining cell 74 by inputting the predicted traffic load of the corresponding representative cell 72 into the corresponding mapping function, and (iii) output the predicted traffic loads 84 for all cells 60 in the population 62, for one or more of network control operations, network planning operations, or resource optimization operations. Note that these prediction-phase operations may be repeated on a prediction interval that is faster than the associated training interval. Further note that the network node 40 may perform these prediction-interval operations with respect to more than one time interval, e.g., the network node 40 may perform traffic-load predictions per minute, per hours, per day, etc., with the understanding that historic traffic data 92 is collected or accumulated for each time interval of interest, and with the further understanding that the new traffic data 82 is collected or accumulated for each time interval of interest.

Broadly, in one or more embodiments, the processing circuitry 110 is configured to repeat its use of the historic traffic data 92 on a first time basis, with the historic traffic data 92 updated with respect to each such repetition. Further, in at least one such embodiment, the processing circuitry 110 is configured to repeat its use of the new traffic data 82 on a second time basis, with the new traffic data 82 updated with respect to each such repetition. The second time basis is shorter than the first time basis, in at least one embodiment. For example, the first time basis is a weekly basis or a monthly basis, and the second time basis is an hourly basis or a daily basis.

Collecting and using the historic traffic data 92 defines a training phase, wherein collecting and using the new traffic data 82 defines a prediction phase. The processing circuitry 110 in one or more embodiments is configured to repeat the training phase according to a defined training phase cycle, with the historic traffic data 92 being updated with respect to each training phase cycle. Further, in such embodiments, the processing circuitry 110 is configured to repeat the prediction phase according to a defined prediction phase cycle, with the new traffic data 82 being updated with respect to each prediction phase cycle.

A size of the new traffic data 82 is a fraction of a size of the historic traffic data 92, based at least on the historic traffic data 92 being collected for all cells 60 in the population 62 and the new traffic data 82 being collected only for the representative cells 72. Basing “live” or runtime prediction operations on new traffic data 82 transferred to the network node 40 only for the representative cells 72 significantly reduces the amount of traffic load data that need to be transmitted from nodes in the RAN 20, for collection and processing by the network node 40. And, as noted, the historic traffic data 92, which does include traffic load information for all cells 60 in the population 62, need not be transferred very often in comparison to the prediction cycle, nor does it need to be transferred all at once.

For outputting the predicted traffic loads 84 for all cells 60 in the population 62, the processing circuitry 110 in one or more embodiments is configured to transfer, via the communication circuitry 100, the predicted traffic loads 84 to a network function that performs online resource optimization in dependence on the predicted traffic loads. See the resource optimization function 120 in FIG. 7, for example. In at least one embodiment, the resource optimization function 120 is a computer node in the CN 30 that is separate from the network node 40.

The processing circuitry 110 in one or more embodiments is configured to collect the historic traffic data from individual nodes in the RAN 20 corresponding to the population 62 of cells 60, or from one or more intermediary nodes in the wireless communication network 10 that aggregate the historic traffic data.

In at least one embodiment, the processing circuitry 110 is configured to determine the corresponding mapping functions by, with respect to each remaining cell 74, being configured to perform one of: (a) determine a scalar value that relates traffic loading in the remaining cell 74 to the corresponding representative cell 72; or determine a vector that relates traffic loading in the remaining cell 74 to the corresponding representative cell 72, the vector comprising a plurality of scalar elements, with each scalar element corresponding to a different one among a plurality of times represented in the historic traffic data. This latter determination is one example of predicting traffic loads with respect to multiple defined time intervals.

For identifying the traffic behavior groups 70, the processing circuitry 110 in one or more embodiments is configured to cluster cells 60 according to spatial relationships or temporal relationships or both. Here, the spatial relationships in question are defined by the respective geographic or network locations of individual cells 60 in the population 62, while the temporal relations are defined by correlations in traffic loads between or among different cells 60 in the population 62.

FIG. 8 illustrates a method 800 of operation by a node in a wireless communication network that includes a RAN—for example, see the network 10 of FIG. 1 and the included network node 40. The method 800 includes the node collecting (Block 802) historic traffic data 92 for all cells 60 in a population 62 of geographically distributed cells 60 provided by the RAN 20. The method 800 continues with the node using the historic traffic data 92 to identify (Block 804) traffic behavior groups 70 among the population 62 of cells 60. Each traffic behavior group 70 is a disjoint subset of two or more cells 60 from the population 62 and contains a representative cell 72 and one or more remaining cells 74.

The node further uses the historic traffic data 92 to determine (Block 806) a corresponding mapping function 122 for each remaining cell 74 in each traffic behavior group 70. The mapping functions 122 determined for each traffic behavior group 70 relate traffic loading in the representative cell 72 to each remaining cell 74. Still further, the node uses the historic traffic data 92 to train (Block 808) a corresponding traffic prediction model 94 for each traffic behavior group 70.

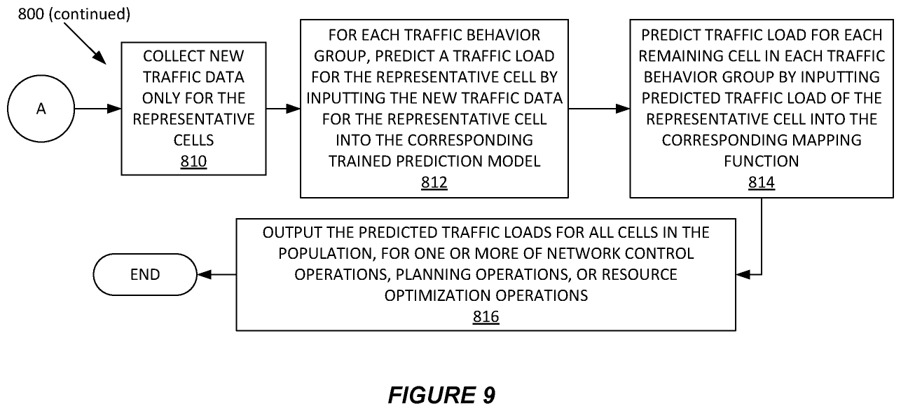

FIG. 9 illustrates the method 800 continuing with collecting (Block 810) new traffic data 82 only for the representative cells 72 and using the new traffic data 82 to predict (Block 812) a traffic load for each representative cell 72 by inputting the new traffic data 82 for the representative cell 72 into the corresponding traffic prediction model 94. Here, the corresponding traffic prediction model 94 for each traffic behavior group 70 is the one trained using relevant portions of the historic traffic data 92 collected for the population 62 of cells 60.

Processing continues with respect to each traffic behavior group 70 by predicting (Block 814) a traffic load for each remaining cell 74 in the group 70 by inputting the predicted traffic load of the corresponding representative cell 74 into the corresponding mapping function 122.

Unlike use of the word “function” in the context of the NFs 32 shown in FIG. 1, which are computer servers or other processing nodes configured to carry out logical functions, each mapping function 122 is a mathematical function either in continuous or discrete form. That is, the mapping function 122 corresponding to each remaining cell 74 in a given traffic behavior group 70 relates the traffic load in the remaining cell 74 to the traffic load in the representative cell 72 of the given traffic behavior group 70. Mapping functions 122 may be stored as polynomials, lookup tables, etc.

Processing in the context of the method 800 continues with outputting (Block 816) the predicted traffic loads 84 for all cells 60 in the population 62. Such outputting is performed for one or more of network control operations, network planning operations, or resource optimization operations.

The method 800 in one or more embodiments includes collecting the historic traffic data 92 on a first time basis, such that the step of using the historic traffic data 92 is repeated on the first time basis, and further includes collecting the new traffic data 82 on a second time basis, such that the step of using the new traffic data 82 is repeated on the second time basis. For example, the operations shown in FIG. 8 are performed on the first time basis and the operations shown in FIG. 9 are performed on the second time basis, with the second time basis being shorter than the first time basis.

Thus, the steps of collecting and using the historic traffic data 92 may be understood as defining a training phase, with the steps of collecting and using the new traffic data 82 defining a prediction phase. Therefore, in one or more embodiments, the method 800 includes repeating the training phase (Blocks 802, 804, 806, and 808) according to a defined training phase cycle, with the historic traffic data 92 being updated with respect to each training phase cycle, and repeating the prediction phase (Blocks 810, 812, 814, and 816) according to a defined prediction phase cycle, with the new traffic data 82 being updated with respect to each prediction phase cycle.

In one or more embodiments, the method 800 further includes any one or any combination of the further operations described above for the network node 40 in the context of carrying out the advantageous prediction technique. For example, the method 800 in at least one embodiment includes outputting the predicted traffic loads 84 for all cells 60 in the population 62, by transferring the predicted traffic loads 84 to a network function 120 that performs online resource optimization in dependence on the predicted traffic loads 84.

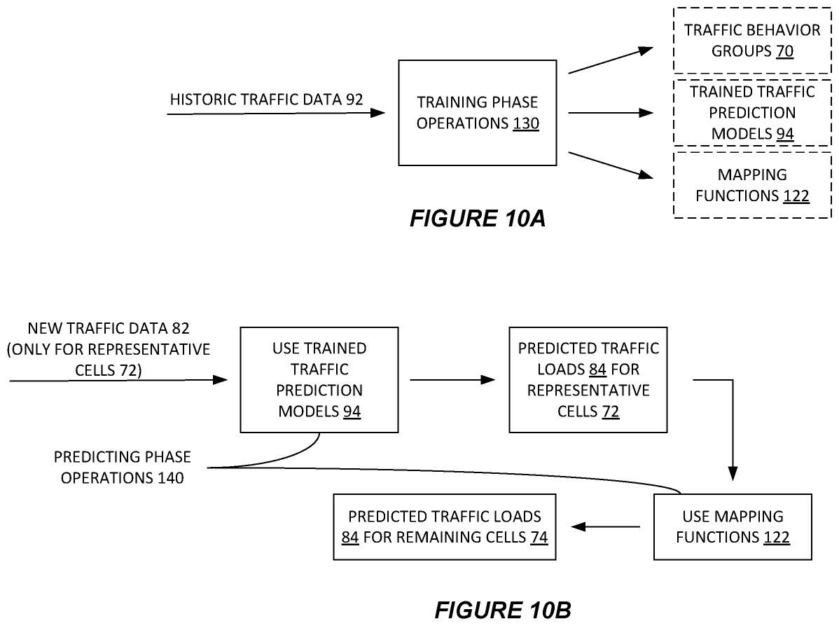

FIG. 10A illustrates example training phase operations 130. The training phase operations 130 use historic traffic data 92 collected for all cells 60 in a population 62 of cells 60 to determine traffic behavior groups 70, to train machine learning models for traffic prediction, thus resulting in a trained traffic prediction model 94 for each traffic behavior group 70, and to determine mapping functions 122. For each traffic behavior group 70, there is a respective mapping function 122 for each remaining cell 74 in the traffic behavior group 70 that relates traffic loading of the representative cell 72 to the remaining cell 74.

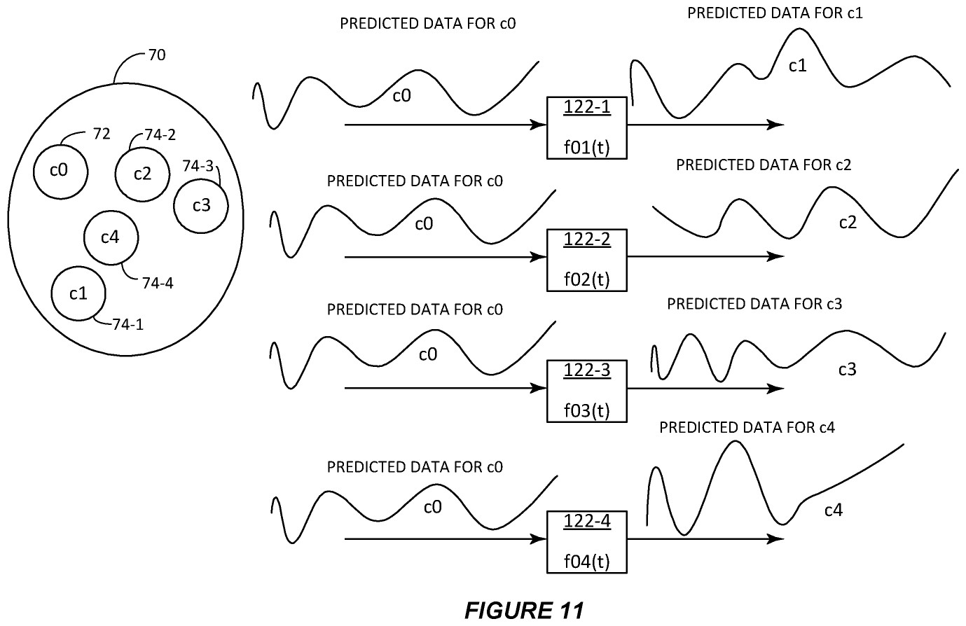

FIG. 10B illustrates example prediction phase operations 140, which may also be referred to as inference phase operations. The prediction phase operations 140 use new traffic data 82 that is current with respect to the involved prediction interval. As noted, the new traffic data 82 contains traffic load information only for the representative cells 72 among the population 62 of cells 60. The new traffic data 82 for each representative cell 72 is fed into the trained traffic prediction model 94 that corresponds to the traffic behavior group 70 of the representative cell 72, to generate a predicted traffic load 84 for the representative cell 72. The predicted traffic loads 84 of the remaining cells 74 in that same traffic behavior group 70 are generated by feeding the predicted traffic load 84 of the representative cell 72 into the respective mapping functions 122 determined for the group. FIG. 11 illustrates such details, where “c0” denotes a representative cell 72 for a given traffic behavior group 70, with “c1”, “c2”, “c3”, and “c4” denoting respective ones of the four remaining cells 74-1, 74-2, 74-3, and 74-4 included in the group. To determine the predicted traffic load for c1, the predicted traffic load of c0 is fed into a mapping function 122-1, to determine the predicted traffic load for c2, the predicted traffic load of c0 is fed into a mapping function 122-2, and so on.

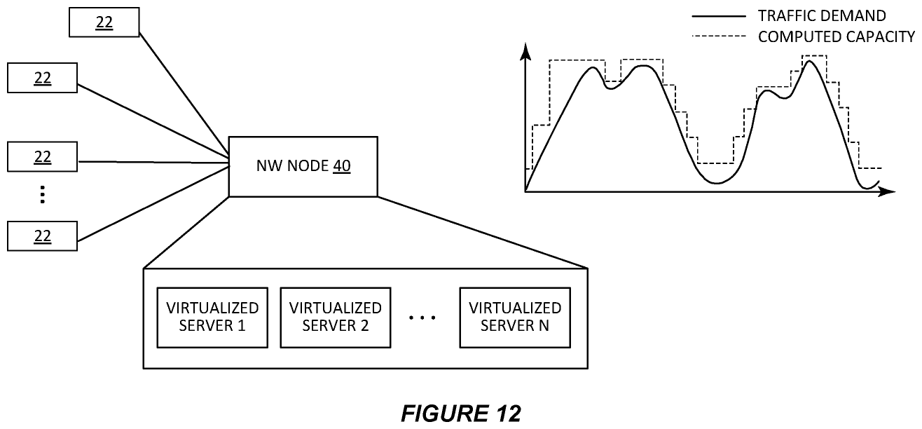

FIG. 12 illustrates a virtualized or cloud embodiment of the network node 40. In this example, the network node 40 has direct or indirect connectivity to the APs 22 of the RAN 20, or at least has access to certain digital portions of such APs 22, which also may be cloud-implemented. In any case, the virtualized network node 40 has access to the aforementioned historic traffic data 92 on a periodic or repeating basis, and further has access to new traffic data 82 on a periodic or recurring basis, and it uses such data to carry out the advantageous prediction technique described herein. A nice aspect of the virtualized network node 40 is that the associated processing load may be provided by any one or more virtualized servers, e.g., based on computational loads or other criteria, or it may be shared among multiple virtualized servers. Here, it will be appreciated that these virtualized servers are instantiated on underlying physical computer systems.

Whether or not virtualization is used, the disclosed prediction technique embodies an efficient method for predicting traffic loads 84 of all cells 60 in a population 62 of cells in a RAN 20, and it advantageously minimizes the amount of data that must be transferred to perform any given prediction. As explained above, the prediction technique is based in part on forming traffic behavior groups 70, which may be understood as a “clustering” procedure. Clustering may be performed on defined interval, e.g., weekly, or monthly, or on some other defined interval, or it may be retriggered, such as by detecting changes in the network 10, like cell additions, layout changes, etc.

One approach to such clustering includes performing clustering—i.e., forming a given set of traffic behavior groups 70—and then monitoring the validity of the clustering as a basis for checking whether to trigger a new clustering. One approach to checking the validity of a current cluster set of traffic behavior groups 70 is to select a fraction of cells 60 per traffic behavior group 70 and re-calculate the same similarity metrics that were used to identify the traffic behavior groups 70. In other words, the selected fraction of cells 60 in each of the current traffic behavior groups 70 should exhibit the same or similar correlations as they did when determining how to cluster the population 62 of cells 60. If the correlations are not similar, e.g., below a defined absolute or relative threshold, re-clustering is triggered.

As for obtaining the trained traffic prediction models 94 corresponding to the respective traffic behavior groups 70, it will be appreciated that training may be ongoing. Further, it will be appreciated that retraining is needed in response to re-clustering—i.e., in response to changing the traffic behavior groupings 70. With the historic traffic data 92 generally being in a time series format, either a time series model approach or a regression type approach may be used for training. Training may use a combination of metrics, such as mean-squared error, mean absolute error, Akaike information criterion (AIC) and Schwarz's Bayesian Information Criterion (BIC).

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of operation by a node in a wireless communication network that includes a cellular Radio Access Network (RAN), the method comprising:
collecting historic traffic data for all cells in a population of geographically distributed cells provided by the RAN;
using the historic traffic data to:
identify traffic behavior groups among the population of cells, each traffic behavior group being a disjoint subset of two or more cells from the population of cells and containing a representative cell and one or more remaining cells;
determine a corresponding mapping function for each remaining cell in each traffic behavior group, the corresponding mapping function relating traffic loading in the representative cell to the remaining cell; and
train a corresponding traffic prediction model for each traffic behavior group; and
collecting new traffic data only for the representative cells; and
using the new traffic data to:
predict a traffic load for each representative cell by inputting the new traffic data for the representative cell into the corresponding traffic prediction model;
predict a traffic load for each remaining cell by inputting the predicted traffic load of the corresponding representative cell into the corresponding mapping function; and
output the predicted traffic loads for all cells in the population, for one or more of network control operations, network planning operations, or resource optimization operations.

2. The method according to claim 1, wherein the method includes collecting the historic traffic data on a first time basis, such that the step of using the historic traffic data is repeated on the first time basis, and further includes collecting the new traffic data on a second time basis, such that the step of using the new traffic data is repeated on the second time basis.

3. The method according to claim 2, wherein the second time basis is shorter than the first time basis.

4. The method according to claim 2, wherein the first time basis is a weekly basis or a monthly basis.

5. The method according to claim 2, wherein the second time basis is an hourly basis or a daily basis.

6. The method according to claim 1, wherein the steps of collecting and using the historic traffic data define a training phase, and wherein the steps of collecting and using the new traffic data define a prediction phase, and wherein the method comprises repeating the training phase according to a defined training phase cycle, with the historic traffic data being updated with respect to each training phase cycle, and repeating the prediction phase according to a defined prediction phase cycle, with the new traffic data being updated with respect to each prediction phase cycle.

7. The method according to claim 1, wherein a size of the new traffic data is a fraction of a size of the historic traffic data, based at least on the historic traffic data being collected for all cells in the population and the new traffic data being collected only for the representative cells.

8. The method according to claim 1, wherein outputting the predicted traffic loads for all cells in the population, comprises transferring the predicted traffic loads to a network function that performs online resource optimization in dependence on the predicted traffic loads.

9. The method according to claim 1, wherein collecting the historic traffic data comprises collecting the historic traffic data from individual nodes in the RAN corresponding to the population of cells, or from one or more intermediary nodes in the wireless communication network that aggregate the historic traffic data.

10. The method according to claim 1, wherein determining the corresponding mapping functions comprises, with respect to each remaining cell, performing one of:
determining a scalar value that relates traffic loading in the remaining cell to the corresponding representative cell;
determining a vector that relates traffic loading in the remaining cell to the corresponding representative cell, the vector comprising a plurality of scalar elements, with each scalar element corresponding to a different one among a plurality of times represented in the historic traffic data.

11. The method according to claim 1, wherein identifying the traffic behavior groups comprises clustering cells according to spatial relationships or temporal relationships or both, wherein the spatial relationships are defined by the respective geographic or network locations of individual cells in the population, and wherein the temporal relations are defined by correlations in traffic loads between or among different cells in the population.

12. A node configured for operation in a wireless communication network that includes a cellular Radio Access Network (RAN), the node comprising:
communication circuitry; and
processing circuitry configured to:
collect historic traffic data for all cells in a population of geographically distributed cells provided by the RAN, the historic traffic data received via the communication circuitry;
use the historic traffic data to:
identify traffic behavior groups among the population of cells, each traffic behavior group being a disjoint subset of two or more cells from the population of cells and containing a representative cell and one or more remaining cells;
determine a corresponding mapping function for each remaining cell in each traffic behavior group, the corresponding mapping function relating traffic loading in the representative cell to the remaining cell; and
train a corresponding traffic prediction model for each traffic behavior group; and
collect new traffic data only for the representative cells, the new traffic data collected via the communication circuitry; and
use the new traffic data to:
predict a traffic load for each representative cell by inputting the new traffic data for the representative cell into the corresponding traffic prediction model;
predict a traffic load for each remaining cell by inputting the predicted traffic load of the corresponding representative cell into the corresponding mapping function; and
output the predicted traffic loads for all cells in the population, for one or more of network control operations, network planning operations, or resource optimization operations.

13. The node according to claim 12, wherein the processing circuitry is configured to repeat its use of the historic traffic data on a first time basis, with the historic traffic data updated with respect to each such repetition, and wherein the processing circuitry is configured to repeat its use of the new traffic data on a second time basis, with the new traffic data updated with respect to each such repetition.

14. The node according to claim 13, wherein the second time basis is shorter than the first time basis.

15. The node according to claim 13, wherein the first time basis is a weekly basis or a monthly basis.

16. The node according to claim 13, wherein the second time basis is an hourly basis or a daily basis.

17. The node according to claim 12, wherein collecting and using the historic traffic data define a training phase, wherein collecting and using the new traffic data define a prediction phase, and wherein the processing circuitry is configured to repeat the training phase according to a defined training phase cycle, with the historic traffic data being updated with respect to each training phase cycle, and repeat the prediction phase according to a defined prediction phase cycle, with the new traffic data being updated with respect to each prediction phase cycle.

18. The node according to claim 12, wherein a size of the new traffic data is a fraction of a size of the historic traffic data, based at least on the historic traffic data being collected for all cells in the population and the new traffic data being collected only for the representative cells.

19. The node according to claim 12, wherein, for outputting the predicted traffic loads for all cells in the population, the processing circuitry is configured to transfer, via the communication circuitry, the predicted traffic loads to a network function that performs online resource optimization in dependence on the predicted traffic loads.

20. The node according to claim 12, wherein the processing circuitry is configured to collect the historic traffic data from individual nodes in the RAN corresponding to the population of cells, or from one or more intermediary nodes in the wireless communication network that aggregate the historic traffic data.

21.-22. (canceled)
